(19) United States
(12) Patent Application Publication
(10) Pub. No.: US 2024/0256936 A1
(43) Pub. Date: Aug. 1, 2024

(54) FOUR-TONE PHASE INSENSITIVE GEOMETRY FOR MØLMER-SØRENSEN INTERACTION WITH CONFINED QUANTUM OBJECTS

(71) Applicant: Quantinuum LLC, Broomfield, CO (US)

(72) Inventors: Michael Feig, Denver, CO (US); John Gaebler, Golden, CO (US)

(21) Appl. No.: 18/391,773

(22) Filed: Dec. 21, 2023

Related U.S. Application Data
(60) Provisional application No. 63/482,178, filed on Jan. 30, 2023.

(51) Int. Cl. G06N 10/40

(52) U.S. Cl. CPC G06N 10/40

(57) ABSTRACT

A quantum computing four-tone phase insensitive Mølmer-Sørensen gate system comprises a confinement apparatus, manipulation source(s), and beam path system(s). The confinement apparatus is configured to confine quantum objects. A qubit space of the quantum objects is defined comprising two qubit states. The manipulation source(s) is configured to generate first, second, third, and fourth manipulation signals. The first and fourth manipulation signals are configured to interact to provide a red sideband signal corresponding to a Raman transition between the two qubit states. The second and third manipulation signals are configured to interact to provide a blue sideband signal corresponding to the Raman transition. The beam path system(s) defines first and second beam paths. The first (second) beam path is configured to provide the first and second (third and fourth) manipulation signals to the defined location. A non-zero angle exists between the first and second beam paths at the defined location.

### CROSS-REFERENCE TO RELATED APPLICATIONS

This application claims priority to U.S. Application No. 63/482,178, filed Jan. 30, 2023, the content of which is incorporated herein by reference in its entirety.

### TECHNICAL FIELD

Embodiments described herein generally relate to quantum logic gates. For example, various embodiments relate to a phase insensitive Mølmer-Sørensen (MS) gate.

### BACKGROUND

Quantum computing may be used to perform advanced computational processing. Quantum logic gates (e.g., controlled NOT gates, Hadamard gates, and/or the like) may be used to provide reliable and fault-tolerant quantum computation. The operation of quantum logic gates in quantum charge-coupled device (QCCD)-based quantum computers often requires lasers that operate using high input power or operate at technologically challenging, difficult, or otherwise inconvenient (e.g., small) wavelengths. These requirements make fast and reliable quantum gates difficult to implement, which may impede scalability in some examples. Through applied effort, ingenuity, and innovation many deficiencies of such systems have been solved by developing solutions that are structured in accordance with the embodiments of the present invention, many examples of which are described in detail herein.

### BRIEF SUMMARY OF EXAMPLE EMBODIMENTS

Example embodiments provide methods for performing phase insensitive MS gate operations and quantum computers, systems, controllers, computer program products, and/or apparatus configured for performing phase insensitive MS gate operations.

In an example embodiment, a quantum system, such as a quantum computer, configured for performing a four-tone phase insensitive MS gate is provided. In various embodiments, methods for causing a quantum system to perform a four-tone phase insensitive MS gates are provided. In various embodiments, a quantum system, such as a quantum computer, comprises a confinement apparatus, one or more manipulation sources, and one or more beam path systems. The confinement apparatus is configured to confine one or more quantum objects at a defined location. A qubit space of the one or more quantum objects is defined to comprise two qubit states. The one or more manipulation sources are configured to generate a first manipulation signal, a second manipulation signal, a third manipulation signal, and a fourth manipulation signal. The first manipulation signal and the fourth manipulation signal are configured, when the first manipulation signal and the fourth manipulation signal interact, to provide a red sideband signal corresponding to a Raman transition between the two qubit states. The second manipulation signal and the third manipulation signal are configured, when the second manipulation signal and the third manipulation signal interact, to provide a blue sideband signal corresponding to the Raman transition between the two qubit states. The one or more beam path systems define a first beam path and a second beam path. The first beam path is configured to provide the first manipulation signal and the second manipulation signal to the defined location and the second beam path is configured to provide the third manipulation signal and the fourth manipulation signal to the defined location. There is a non-zero angle between the first beam path and the second beam path at the defined location. The quantum system is configured to provide the first manipulation signal and the second manipulation signal to the defined location via the first optical path and to provide the third manipulation signal and the fourth manipulation signal to the defined location via the second optical path simultaneously and/or at the same time.

According to a first aspect, a system configured for performing a Mølmer-Sørensen (MS) gate is provided. In an example embodiment, the system comprises a confinement apparatus configured to confine one or more quantum objects at a defined location. A qubit space of the one or more quantum objects is defined to comprise two qubit states. The system further comprises one or more manipulation sources configured to generate a first manipulation signal, a second manipulation signal, a third manipulation signal, and a fourth manipulation signal. The first manipulation signal and the fourth manipulation signal are configured, when the first manipulation signal and the fourth manipulation signal interact, to provide a red sideband signal corresponding to a Raman transition between the two qubit states. The second manipulation signal and the third manipulation signal are configured, when the second manipulation signal and the third manipulation signal interact, to provide a blue sideband signal corresponding to the Raman transition between the two qubit states. The system further comprises one or more beam path systems. The one or more beam path systems define a first beam path and a second beam path. The first beam path is configured to provide the first manipulation signal and the second manipulation signal to the defined location and the second beam path is configured to provide the third manipulation signal and the fourth manipulation signal to the defined location (simultaneously). There is a non-zero angle between the first beam path and the second beam path at the defined location.

In an example embodiment, (a) a qubit frequency is defined based on an energy difference between the two qubit states of the qubit space of the one or more quantum objects, (b) a first frequency of the first manipulation signal corresponds to a Raman laser frequency, (c) a second frequency of the second manipulation signal corresponds to a sum of the Raman laser frequency, the qubit frequency, and a motional frequency of the two or more quantum objects, (d) a third frequency of the third manipulation signal corresponds to the Raman laser frequency, and (e) a fourth frequency of the fourth manipulation signal corresponds to the Raman laser frequency plus the qubit frequency minus the motional frequency.

In an example embodiment, one of (a) the first frequency is equal to the Raman laser frequency plus a carrier detuning and the fourth frequency is equal to the Raman laser frequency plus the qubit frequency minus the motional frequency plus the carrier detuning or (b) the second frequency is equal to the sum of the Raman laser frequency, the qubit frequency, and a motional frequency plus the carrier detuning and the third frequency is equal to the Raman laser frequency plus the carrier detuning.

In an example embodiment, the motional frequency is a sum of a motional mode frequency defined by the confinement apparatus and a mode detuning.

In an example embodiment, the MS gate is a phase insensitive MS gate.

In an example embodiment, the confinement apparatus is configured to cause two quantum objects of the one or more quantum objects to be located at the defined location with a separation distance between the two quantum objects to be one of an integer multiple or a half odd integer of π divided by an amplitude of a wave vector difference between (a) one of the first manipulation signal or the second manipulation signal and (b) one of the third manipulation signal or the fourth manipulation signal.

In an example embodiment, the non-zero angle is an angle between thirty degrees and one hundred fifty degrees.

In an example embodiment, a magnetic field direction at the defined location is configured to be substantially parallel to one of the first beam path or the second beam path at the defined location.

In an example embodiment, the system further comprises a controller configured to control operation of one or more of the confinement apparatus, the one or more manipulation sources, or the one or more beam path systems to cause the system to perform the MS gate.

In an example embodiment, the controller is configured to cause the first manipulation signal, second manipulation signal, third manipulation signal, and fourth manipulation signal to be provided to the defined location simultaneously.

According to another aspect, a method for performing a four-tone phase insensitive Mølmer-Sørensen (MS) gate is provided. In an example embodiment, the method comprises controlling operation of a confinement apparatus confining two or more quantum objects to cause the two or more quantum objects to be located at a defined location of the confinement apparatus. A qubit space of the one or more quantum objects is defined to comprise two qubit states. The method further comprises controlling operation of one or more manipulation sources to cause generation of a first manipulation signal, a second manipulation signal, a third manipulation signal, and a fourth manipulation signal. The first manipulation signal and the fourth manipulation signal are configured, when the first manipulation signal and the fourth manipulation signal interact, to provide a red sideband signal corresponding to a Raman transition between the two qubit states. The second manipulation signal and the third manipulation signal are configured, when the second manipulation signal and the third manipulation signal interact, to provide a blue sideband signal corresponding to the Raman transition between the two qubit states. The first manipulation signal and the second manipulation signal are provided to the defined location via a first beam path and the third manipulation signal and the fourth manipulation signal are provided to the defined location via a second beam path (simultaneously) to cause the first manipulation signal and the fourth manipulation signal to interact to provide the red sideband signal and to cause the second manipulation signal and the third manipulation signal to interact to provide the blue sideband signal. There is a non-zero angle between the first beam path and the second beam path at the defined location.

In an example embodiment, (a) a qubit frequency is defined based on an energy difference between the two qubit states of the qubit space of the one or more quantum objects, (b) a first frequency of the first manipulation signal corresponds to a Raman laser frequency, (c) a second frequency of the second manipulation signal corresponds to a sum of the Raman laser frequency, the qubit frequency, and a motional frequency of the two or more quantum objects, (d) a third frequency of the third manipulation signal corresponds to the Raman laser frequency, and (e) a fourth frequency of the fourth manipulation signal corresponds to the Raman laser frequency plus the qubit frequency minus the motional frequency.

In an example embodiment, one of (a) the first frequency is equal to the Raman laser frequency plus a carrier detuning and the fourth frequency is equal to the Raman laser frequency plus the qubit frequency minus the motional frequency plus the carrier detuning or (b) the second frequency is equal to the sum of the Raman laser frequency, the qubit frequency, and a motional frequency plus the carrier detuning and the third frequency is equal to the Raman laser frequency plus the carrier detuning.

In an example embodiment, the motional frequency is a sum of a motional mode frequency defined by the confinement apparatus and a mode detuning.

In an example embodiment, the MS gate is a phase insensitive MS gate.

In an example embodiment, the operation of the confinement apparatus is controlled to cause the two or more quantum objects to be located at the defined location with a separation distance between two or the two or more quantum objects to be one of an integer multiple or half odd integer of π divided by an amplitude of a wave vector difference between (a) one of the first manipulation signal or the second manipulation signal and (b) one of the third manipulation signal or the fourth manipulation signal.

In an example embodiment, the MS gate is part of a quantum logic operation.

In an example embodiment, the MS gate is performed as part of a quantum circuit.

In an example embodiment, the method further comprises controlling operation of one or more beam path systems defining the first beam path and the second beam path to cause the first manipulation signal and the second manipulation signal to be provided to the defined location via the first beam path and the third manipulation signal and the fourth manipulation signal to be provided to the defined location via a second beam path.

In an example embodiment, at least a portion of the method is performed by a controller configured to control operation of one or more of the confinement apparatus, the one or more manipulation sources, or one or more beam path systems defining the first beam path and the second beam path.

In an example embodiment, the controller is configured to control operation of the one or more manipulation sources and/or the one or more beam path systems to cause the first manipulation signal, second manipulation signal, third manipulation signal, and fourth manipulation signal to be provided to the defined location at the simultaneously and/or at the same time.

In an example embodiment, the non-zero angle is an angle between thirty degrees and one hundred fifty degrees.

According to another aspect, a computer program product comprising a non-transitory, machine-readable storage medium storing a plurality of executable instructions that, when executed with a processing device of a controller of a quantum computer, cause the controller to perform the steps of controlling operation of a confinement apparatus confining two or more quantum objects to cause the two or more quantum objects to be located at a defined location of the confinement apparatus, wherein a qubit space of the one or more quantum objects is defined to comprise two qubit states; and controlling operation of one or more manipulation sources to cause generation of a first manipulation signal, a second manipulation signal, a third manipulation signal, and a fourth manipulation signal. The first manipulation signal and the fourth manipulation signal are configured, when the first manipulation signal and the fourth manipulation signal interact, to provide a red sideband signal corresponding to a Raman transition between the two qubit states. The second manipulation signal and the third manipulation signal are configured, when the second manipulation signal and the third manipulation signal interact, to provide a blue sideband signal corresponding to the Raman transition between the two qubit states. The first manipulation signal and the second manipulation signal are provided to the defined location via a first beam path and the third manipulation signal and the fourth manipulation signal are provided to the defined location via a second beam path (simultaneously) to cause the first manipulation signal and the fourth manipulation signal to interact to provide the red sideband signal and to cause the second manipulation signal and the third manipulation signal to interact to provide the blue sideband signal. There is a non-zero angle between the first beam path and the second beam path at the defined location.

In an example embodiment, (a) a qubit frequency is defined based on an energy difference between the two qubit states of the qubit space of the one or more quantum objects, (b) a first frequency of the first manipulation signal corresponds to a Raman laser frequency, (c) a second frequency of the second manipulation signal corresponds to a sum of the Raman laser frequency, the qubit frequency, and a motional frequency of the two or more quantum objects, (d) a third frequency of the third manipulation signal corresponds to the Raman laser frequency, and (e) a fourth frequency of the fourth manipulation signal corresponds to the Raman laser frequency plus the qubit frequency minus the motional frequency.

In an example embodiment, one of (a) the first frequency is equal to the Raman laser frequency plus a carrier detuning and the fourth frequency is equal to the Raman laser frequency plus the qubit frequency minus the motional frequency plus the carrier detuning or (b) the second frequency is equal to the sum of the Raman laser frequency, the qubit frequency, and a motional frequency plus the carrier detuning and the third frequency is equal to the Raman laser frequency plus the carrier detuning.

In an example embodiment, the motional frequency is a sum of a motional mode frequency defined by the confinement apparatus and a mode detuning.

In an example embodiment, the MS gate is a phase insensitive MS gate.

In an example embodiment, the operation of the confinement apparatus is controlled to cause the two or more quantum objects to be located at the defined location with a separation distance between two or the two or more quantum objects to be one of an integer multiple or a half odd integer of π divided by an amplitude of a wave vector difference between (a) one of the first manipulation signal or the second manipulation signal and (b) one of the third manipulation signal or the fourth manipulation signal.

In an example embodiment, the MS gate is part of a quantum logic operation.

In an example embodiment, the MS gate is performed as part of a quantum circuit.

In an example embodiment, the executable instructions, when executed with the processing device of the controller of the quantum computer, cause the controller to perform the step of controlling operation of one or more beam path systems defining the first beam path and the second beam path to cause the first manipulation signal and the second manipulation signal to be provided to the defined location via the first beam path and the third manipulation signal and the fourth manipulation signal to be provided to the defined location via a second beam path.

In an example embodiment, the executable instructions, when executed with the processing device of the controller of the quantum computer, cause the controller to control operation of the one or more manipulation sources and/or the one or more beam path systems to cause the first manipulation signal, second manipulation signal, third manipulation signal, and fourth manipulation signal to be provided to the defined location at the simultaneously and/or at the same time.

In an example embodiment, the non-zero angle is an angle between thirty degrees and one hundred fifty degrees.

According to another aspect, a controller of a quantum computer is provided. The quantum computer comprises a confinement apparatus configured to confine one or more quantum objects at a defined location, one or more manipulation sources, and one or more beam path systems defining a first beam path and a second beam path. In an example embodiment, the controller comprises at least one processing device and a memory storing executable instructions, the executable instructions, when executed by the at least one processing device, are configured to cause the controller to perform the steps of controlling operation of the confinement apparatus confining two or more quantum objects to cause the two or more quantum objects to be located at the defined location of the confinement apparatus, wherein a qubit space of the one or more quantum objects is defined to comprise two qubit states; and controlling operation of the one or more manipulation sources to cause generation of a first manipulation signal, a second manipulation signal, a third manipulation signal, and a fourth manipulation signal. The first manipulation signal and the fourth manipulation signal are configured, when the first manipulation signal and the fourth manipulation signal interact, to provide a red sideband signal corresponding to a Raman transition between the two qubit states. The second manipulation signal and the third manipulation signal are configured, when the second manipulation signal and the third manipulation signal interact, to provide a blue sideband signal corresponding to the Raman transition between the two qubit states. The first manipulation signal and the second manipulation signal are provided to the defined location via the first beam path and the third manipulation signal and the fourth manipulation signal are provided to the defined location via the second beam path (simultaneously) to cause the first manipulation signal and the fourth manipulation signal to interact to provide the red sideband signal and to cause the second manipulation signal and the third manipulation signal to interact to provide the blue sideband signal. There is a non-zero angle between the first beam path and the second beam path at the defined location.

In an example embodiment, (a) a qubit frequency is defined based on an energy difference between the two qubit states of the qubit space of the one or more quantum objects, (b) a first frequency of the first manipulation signal corresponds to a Raman laser frequency, (c) a second frequency of the second manipulation signal corresponds to a sum of the Raman laser frequency, the qubit frequency, and a motional frequency of the two or more quantum objects, (d) a third frequency of the third manipulation signal corresponds to the Raman laser frequency, and (e) a fourth frequency of the fourth manipulation signal corresponds to the Raman laser frequency plus the qubit frequency minus the motional frequency.

In an example embodiment, one of (a) the first frequency is equal to the Raman laser frequency plus a carrier detuning and the fourth frequency is equal to the Raman laser frequency plus the qubit frequency minus the motional frequency plus the carrier detuning or (b) the second frequency is equal to the sum of the Raman laser frequency, the qubit frequency, and a motional frequency plus the carrier detuning and the third frequency is equal to the Raman laser frequency plus the carrier detuning.

In an example embodiment, the motional frequency is a sum of a motional mode frequency defined by the confinement apparatus and a mode detuning.

In an example embodiment, the MS gate is a phase insensitive MS gate.

In an example embodiment, the operation of the confinement apparatus is controlled to cause the two or more quantum objects to be located at the defined location with a separation distance between two or the two or more quantum objects to be one of an integer multiple or half odd integer of π divided by an amplitude of a wave vector difference between (a) one of the first manipulation signal or the second manipulation signal and (b) one of the third manipulation signal or the fourth manipulation signal.

In an example embodiment, the MS gate is part of a quantum logic operation.

In an example embodiment, the MS gate is performed as part of a quantum circuit.

In an example embodiment, the controller is further configured to control operation of one or more beam path systems defining the first beam path and the second beam path to cause the first manipulation signal and the second manipulation signal to be provided to the defined location via the first beam path and the third manipulation signal and the fourth manipulation signal to be provided to the defined location via a second beam path.

In an example embodiment, the executable instructions, when executed with the at least one processing device of the controller, cause the controller to control operation of the one or more manipulation sources and/or the one or more beam path systems to cause the first manipulation signal, second manipulation signal, third manipulation signal, and fourth manipulation signal to be provided to the defined location at the simultaneously and/or at the same time.

In an example embodiment, the non-zero angle is an angle between thirty degrees and one hundred fifty degrees.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides block diagram of an example QCCD-based quantum computer, in accordance with an example embodiment.

FIG. 2 provides a schematic diagram showing the performance of an example phase insensitive gate on a pair of quantum objects, according to an example embodiment corresponding to the state transition diagram shown in FIG. 3.

FIG. 3 provides a state transition diagram, according to an example embodiment.

FIG. 4 provides a flowchart illustrating processes, procedures, and operations performed, for example, by a controller of a quantum computer, to perform a phase insensitive MS gate on two or more quantum objects, according to an example embodiment.

FIG. 5 provides a schematic diagram of an example controller of a quantum computer comprising an ion trap apparatus, in accordance with an example embodiment.

FIG. 6 provides a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “substantially,” “generally,” and “approximately” refer to within appropriate engineering and/or manufacturing tolerances and/or within user measurement capabilities, unless otherwise indicated. Like numbers refer to like elements throughout.

In various embodiments of a quantum computer, sequences of various quantum logic gates are performed on qubits to perform a quantum calculation, program, and/or circuit. The Mølmer-Sørensen (MS) gate is a two-qubit (or possibly more than two-qubit) entangling interaction that is commonly used as a building block of a universal quantum computation set. For example, a controlled NOT gate (a CNOT gate) can be decomposed into a sequence of single-qubit gates and an MS gate. Conventionally, in QCCD-based quantum computers, MS gates are performed using three laser beams in either a phase sensitive geometry or a phase insensitive geometry.

In the three beam phase sensitive geometry, the gate is performed by causing three laser beams to be incident on a pair of qubit ions. Two of the laser beams are co-propagating and a third laser beam is not co-propagating with the first two laser beams. The frequency difference between the two co-propagating laser beams is approximately the motional frequency of the qubit ions. In the phase sensitive geometry, the spin phase of the gate, which controls the axis of the two-qubit rotation caused by the gate, is sensitive to fluctuations or changes in the relative beam path lengths of the two beam paths. This requires application of additional single qubit gates to address this phase sensitivity. These additional single qubit gates may introduce additional noise into the computation.

In the three beam phase insensitive geometry, the gate is also performed by causing three laser beams to be incident on a pair of qubit ions. Two of the laser beams are co-propagating laser beams and the third laser beam does not co-propagate with the first two laser beams. The frequency difference of the co-propagating red-shifted beam and the blue-shifted beam is approximately twice the qubit frequency (e.g., approximately 25 GHz in the case of a Yb⁺ qubit). Generating beams with this frequency difference is technically challenging and may require an additional laser source.

Therefore, technical challenges exist regarding performance of a high fidelity, low noise MS gate that is technically feasible to implement.

Embodiments disclosed herein provide a technical solution to these technical problems. In particular, various embodiments provide a four manipulation signal phase insensitive MS gate where the four manipulation signals are straight forward to generate using two laser sources. Because the disclosed MS gate is phase insensitive, the additional single qubit gates used to address the phase sensitivity of the three beam phase sensitive MS gate are not needed. Thus, various embodiments of the MS gate disclosed herein provide higher fidelity, lower noise MS gates compared to conventional MS gates while being technically straight forward to implement in light of the disclosure provided herein. Various embodiments therefore provide improvements to the technical fields of quantum computing and controlled quantum state evolution of quantum objects.

Various embodiments provide methods for performing a phase insensitive MS gate using four manipulation signals that are applied to two or more quantum objects as two pairs of co-propagating manipulation signals with a non-zero angle α between the two pairs of co-propagating manipulation signals at the location of the quantum objects. For example, a confinement apparatus confines a plurality of quantum objects. Two or more of the quantum objects are confined at a defined location of the confinement apparatus and the MS gate is performed on the two or more quantum objects at the defined location by causing a first manipulation signal and a second manipulation signal to be provided to the defined location via a first optical path and a third manipulation signal and a fourth manipulation signal to be provided to the defined location via a second optical path. The first optical path and the second optical path are not parallel (e.g., have a non-zero angle α therebetween) at the defined location.

The first manipulation signal, provided to the defined location via the first optical path, interacts at the defined location with the fourth manipulation signal, provided to the defined location via the second optical path, to generate a red sideband signal at the defined location. The interaction of the red sideband signal with the two or more quantum objects confined at the defined location causes a red sideband interaction of the two or more quantum objects. The second manipulation signal, provided to the defined location via the first optical path, interacts at the defined location with the third manipulation signal, provided to the defined location via the second optical path, to generate a blue sideband signal at the defined location. The interaction of the blue sideband signal with the two or more quantum objects confined at the defined location causes a blue sideband interaction of the two or more quantum objects. The simultaneous interaction of the red sideband signal and the blue sideband signal with the two or more quantum objects causes and/or results in the performance of the qubit entanglement of the MS gate.

### Exemplary Quantum Computer System

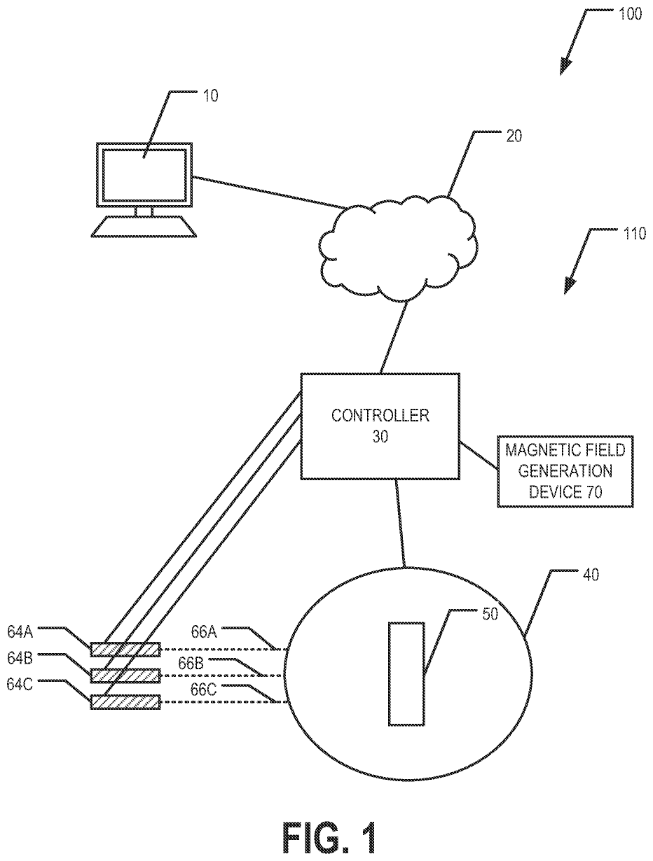

In various embodiments, an MS gate is performed by a quantum processor of a quantum computer system. In various embodiments, an MS gate is performed by a quantum system configured to control evolution of the respective quantum states of various quantum objects. FIG. 1 provides a block diagram of an example quantum computer system 100 which may be used to perform MS gates of various embodiments.

FIG. 1 provides a block diagram of an example QCCD-based quantum computer system 100. In various embodiments, the quantum computer system 100 comprises a computing entity 10 and a quantum computer 110. In various embodiments, the quantum computer 110 comprises a controller 30, a cryogenic and/or vacuum chamber 40 enclosing a confinement apparatus 50 (e.g., an ion trap and/or the like), a magnetic field generation device 70, one or more manipulation sources 64 (e.g., 64A, 64B, 64C), and/or the like.

In various embodiments, the confinement apparatus 50 is configured to confine a plurality of quantum objects. For example, in various embodiments the quantum objects are neutral or ionic atoms; neutral, ionic, and/or multipole molecules; quantum dots; and/or other quantum particles. In various embodiments, the confinement apparatus 50 confines the plurality of quantum objects for use as qubits of the quantum computer 110. In various embodiments, the quantum computer 110 comprises a plurality of potential drivers (e.g., voltage sources and/or the like) used to control operation of the confinement apparatus 50. For example, the controller 30 is configured to control operation of the plurality of potential drivers so as to control the operation of the confinement apparatus 50.

In an example embodiment, the one or more manipulation sources 64 may comprise one or more lasers (e.g., optical lasers, and/or the like), microwave field sources, and/or the like. In various embodiments, the one or more manipulation sources 64 are configured to manipulate and/or cause a controlled quantum state evolution of one or more quantum objects (e.g., qubits) within the confinement apparatus 50. For example, in an example embodiment, wherein the one or more manipulation sources 64 comprise one or more lasers, the lasers may provide one or more laser beams to the confinement apparatus 50 within the cryogenic and/or vacuum chamber 40. In various embodiments, the manipulation sources 64 may be used to generate manipulation signals that are used to perform gate operations, cooling operations, leakage suppression operations, and/or the like. In an example embodiment, the one or more manipulation sources 64 each provide a laser beam and/or the like to the confinement apparatus 50 via a corresponding beam path system 66 (e.g., 66A, 66B, 66C). In various embodiments, at least one beam path system 66 comprises a modulator configured to modulate the manipulation signal being provided to the confinement apparatus 50 via the beam path system 66. In various embodiments, the manipulation sources 64, active components of the beam path systems 66 (e.g., modulators and/or the like), and/or other components of the quantum computer 110 are controlled by the controller 30.

In various embodiments, the manipulation sources 64 comprise one or more manipulation sources configured to generate the first, second, third, and fourth manipulation signals used to perform the MS gate. In various embodiments, the one or more manipulation sources 64 configured to generate the first, second, third, and fourth manipulation signals used to perform the MS gate comprise one or more continuous wave lasers, one or more modulators, one or more beam splitters, one or more amplifiers, and/or the like. In various embodiments, one or more of the beam path systems 66 define the first optical path along which the first and second manipulation signals are provided to the defined location and the second optical path along which the third and fourth manipulation signals are provided to the defined location.

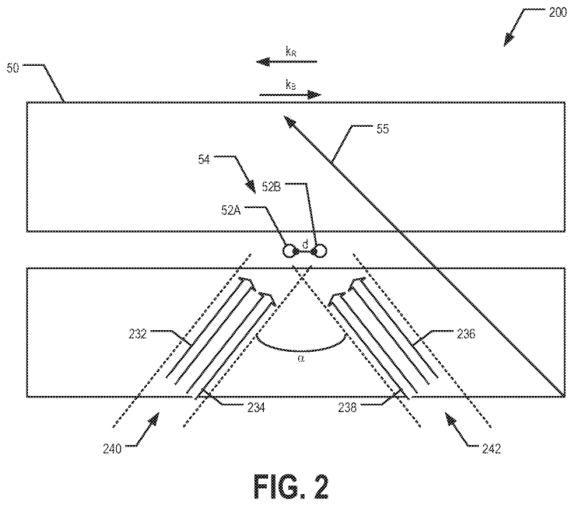

In various embodiments, the magnetic field generation device 70 may comprise circuitry coupled to a voltage source (e.g., a current driver or voltage driver), one or more permanent magnets, and/or a combination thereof for generating a magnetic field having a magnetic field direction 55 (see FIG. 2) and desired magnetic field amplitude at one or more defined locations 54 of the confinement apparatus 50. In various embodiments, the controller 30 is configured to control operation of the voltage source.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms, and/or the like into a computing language, executable instructions, command sets, and/or the like that the controller 30 can understand, execute, and/or implement.

In various embodiments, the controller 30 is configured to control potential drivers (e.g., voltage sources and/or the like) controlling the confinement apparatus 50 and/or confinement and transport of quantum objects within the confinement apparatus 50; a cryogenic system and/or vacuum system controlling the temperature, pressure, and/or other environmental parameters within the cryogenic and/or vacuum chamber 40; manipulation sources 64; beam path systems 66; and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more quantum objects confined by the confinement apparatus 50. In various embodiments, the quantum objects confined by the confinement apparatus 50 are used as qubits of the quantum computer 110.

### Example Four-Tone Phase Insensitive MS Gate

Various embodiments provide methods for performing a four-tone phase insensitive MS gate and quantum computers, quantum systems, controllers, and/or apparatus configured and/or programmed to implement an example embodiment of the four-tone phase insensitive MS gate. Example embodiments of the MS gate disclosed herein are referred to as a four-tone gate because the performance of the gate includes the application of four manipulation signals to the defined location where the gate is being performed. In various embodiments, the respective frequencies of the four manipulation signals are unique and/or different from one another. Example embodiments of the MS gate disclosed herein are referred to as phase insensitive because the performance of the gate is not dependent on the spin phase of the quantum objects and/or the optical phase of the four manipulation signals applied to the quantum objects to perform the gate.

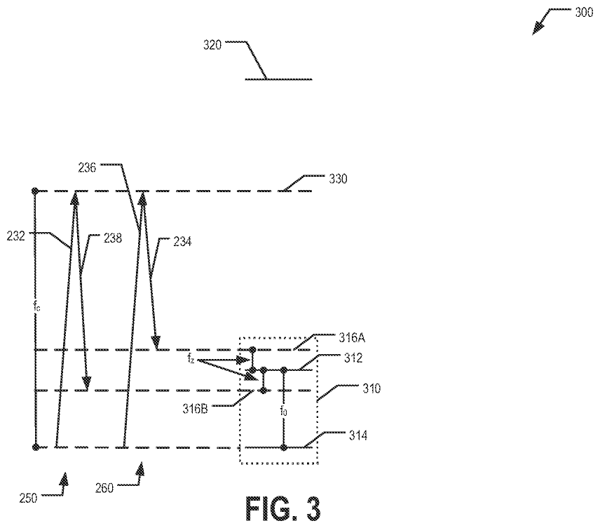

For example, FIG. 2 provides a schematic diagram showing the performance of an example four-tone phase insensitive MS gate on quantum objects 52A, 52B confined by a confinement apparatus 50, according to the example embodiment. FIG. 3 provides a state transition diagram, according to the example embodiment illustrated in FIG. 2.

FIG. 2 illustrates a pair of quantum objects 52A, 52B disposed at a defined location 54 of the confinement apparatus 50. In an example embodiment, the defined location 54 is defined by the confinement apparatus 50. A first optical path 240 is configured to provide a first manipulation signal 232 and a second manipulation signal 234 to the defined location 54. A second optical path 242 is configured to provide a third manipulation signal 236 and a fourth manipulation signal 238 to the defined location 54. At the defined location 54, there is a non-zero angle α between the first optical path 240 and the second optical path 242. In various embodiments, the first and second optical paths 240, 242 are defined by one or more bulk optics, optical fibers, waveguides, photonic-integrated circuit (PIC) components, and/or the like of one or more optical beam path systems 66.

In various embodiments, the first manipulation signal 232 is characterized by a first frequency f₁. For example, in an example embodiment, the first manipulation signal 232 is a continuous wave laser beam of frequency f₁. In various embodiments, the first frequency f₁ corresponds to a Raman laser frequency f_{c}. In an example embodiment where the quantum objects are singly ionized Yb171, the Raman laser frequency f_{c} is approximately 800 THz. In an example embodiment, the first frequency f₁ equals the Raman laser frequency f_{c}. In an example embodiment, the first frequency f₁ is equal to the Raman laser frequency f_{c} plus a carrier detuning Δ. In an example embodiment, the absolute value of the carrier detuning |Δ| is in a range of 100 kHz to 100 MHz. For example, in an example embodiment, the absolute value of the carrier detuning is selected within the range 1 to 10 MHz. As should be understood, the carrier detuning Δ may be positive or negative.

In various embodiments, the second manipulation signal 234 is characterized by a second frequency f₂. For example, in an example embodiment, the second manipulation signal 234 is a continuous wave laser beam of frequency f₂. In various embodiments the second frequency f₂ corresponds to a sum of the Raman laser frequency f_{c}, the qubit frequency f₀, and a motional frequency of the two or more quantum objects 52A, 52B. In an example embodiment, the second frequency f₂ equals the sum of the Raman laser frequency f_{c}, the qubit frequency f₀, and a motional frequency (f_{z}+δ) of the two or more quantum objects 52A, 52B (e.g., f₂=f_{c}+f₀+(f_{z}+δ)). In an example embodiment, the motional frequency is a sum of the motional mode frequency f_{z} defined at least in part by the confinement apparatus and the quantum objects 52A, 52B and a mode detuning δ. In various embodiments, the motional mode frequency f_{z} is a function of the voltages applied to control electrodes and/or radio frequency electrodes of the confinement apparatus (e.g., by the potential drivers of the quantum computer 110). For example, the motional mode frequency f_{z} is determined at least in part based on the topology of the potential well in which the two or more quantum objects 52A, 52B are disposed. In various embodiments, the mode detuning δ is in a range between 1 kHz and 1 MHz (e.g., corresponding to gate times between 1 ms and 1 ρs). In various embodiments, the mode detuning δ is less than 1 kHz or greater than 1 MHz. In various embodiments, the mode detuning δ is used to determine the length of time the gate is performed for (e.g., the length of time the first, second, third, and fourth manipulation signals are applied to the defined location 54 to cause performance of the gate). In various embodiments, the length of time of the gate is proportional to 1/δ.

FIG. 3 provides a partial energy diagram of an example quantum object 52 (e.g., 52A, 52B). The partial energy diagram 300 illustrates a qubit space 310 defined to include a first qubit state 312 and a second qubit state 314. The qubit frequency f₀ is the frequency corresponding to the energy difference between the first qubit state 312 and the second qubit state 314. In an example embodiment, the first qubit state 312 and the second qubit state 314 are clock states of the ground state manifold of the quantum object 52. For example, in an example embodiment where the quantum objects are singly ionized Ba¹³⁷, the first qubit state 312 is the F=2, m=0, S^{1/2} state and second qubit state 314 is the F=1, m=0, S^{1/2} state of the quantum objects 52. In another example embodiment where the quantum objects are singly ionized Yb¹⁷¹, the first qubit state 312 is the F=1, m=0, S^{1/2} state and second qubit state 314 is the F=0, m=0, S^{1/2} state of the quantum objects 52. The partial energy diagram also illustrates an excited state and/or excited manifold of hyperfine states 320.

The Raman laser frequency f_{c} is a frequency that is less than the frequency corresponding to the energy difference between the first and second qubit states 312, 314 of the qubit space 310 and the excited state and/or excited manifold of hyperfine states 320. For example, the Raman laser frequency f_{c} is configured and/or selected to drive a Raman transition between the first qubit state 312 and the second qubit state 314 or vice versa. For example, the Raman laser frequency f_{c} corresponds to the energy difference between the second qubit state 314 (e.g., the lower energy state of the qubit space 310) and virtual state 330, which has an energy between that of the first qubit state 312 (e.g., the higher energy state of the qubit space 310) and the excited state and/or excited manifold of hyperfine states 320.

In various embodiments, the Raman laser frequency f_{c} is determined and/or selected based on one or more criteria. In an example embodiment, the one or more criteria include a minimum detuning from the frequency corresponding to the transition between the first and/or second qubit state 312, 314 and the excited state and/or excited manifold of hyperfine states 320. In an example embodiment, the minimum detuning is determined and/or defined so as to not incur more spontaneous emission than the system can tolerate while still meeting given gate fidelity goals. In an example embodiment, the one or more criteria include a maximum detuning from the frequency corresponding to the transition between the first and/or second qubit state 312, 314 and the excited state and/or excited manifold of hyperfine states 320. In various embodiments, the maximum detuning is determined and/or defined such that the power of the manipulation source generating and/or providing the manipulation signal(s) (e.g., the first, second, third, and/or fourth manipulations signals 232, 234, 236, 238) is sufficient to drive the gate interaction within a set time frame.

In various embodiments, the third manipulation signal 236 is characterized by a third frequency f₃. For example, in an example embodiment, the third manipulation signal 236 is a continuous wave laser beam of frequency f₃. In various embodiments, the third frequency f₃ corresponds to a Raman laser frequency f_{c}. In an example embodiment where the quantum objects are singly ionized Yb171, the Raman laser frequency f_{c} is approximately 800 THz. In an example embodiment, the third frequency f₃ equals the Raman laser frequency f_{c}. In an example embodiment, the third frequency f₃ is equal to the Raman laser frequency f_{c} plus a carrier detuning Δ. In an example embodiment, the carrier detuning Δ is in a range of 100 kHz to 100 MHz. For example, in an example embodiment, the carrier detuning is selected within the range 1 to 10 MHz.

In various embodiments, at most one of the first frequency f₁ and the third frequency f₃ is modified by the carrier detuning Δ. For example, in an example embodiment, both the first frequency and the third frequency are equal to the Raman laser frequency (e.g., f₁=f₃=f_{c}). In an example embodiment, the first frequency is equal to the Raman laser frequency and the third frequency is equal to the Raman laser frequency modified by the carrier detuning (e.g., f₁=f_{c} and f₃=f_{c}+Δ). In another example embodiment, the first frequency is equal to the Raman laser frequency modified by the carrier detuning and the third frequency is equal to the Raman laser frequency (e.g., f₁=f_{c}+Δ and f₃=f_{c}).

In various embodiments, the third frequency is configured such that the difference between the second frequency and the third frequency is equal to the sum of the qubit frequency and the motional frequency (e.g., |f₂−f₃|=f₀+(f_{z}+δ). For example, in embodiments where the third frequency is equal to the Raman laser frequency modified by the carrier detuning Δ, the second frequency f₂ may also be modified by the carrier detuning Δ such that f₂=f_{c}+f₀+(f_{z}+δ)+Δ when f₃=f_{c}+Δ.

In various embodiments, the fourth manipulation signal 238 is characterized by a fourth frequency f₄. For example, in an example embodiment, the fourth manipulation signal 238 is a continuous wave laser beam of frequency f₄. In various embodiments the fourth frequency f₄ corresponds to the Raman laser frequency f_{c} plus the qubit frequency f₀ and minus a motional frequency of the two or more quantum objects 52A, 52B. In an example embodiment, the fourth frequency f₄ equals the Raman laser frequency f_{c} plus the qubit frequency f₀ and minus a motional frequency (f_{z}+δ) of the two or more quantum objects 52A, 52B (e.g., f₂=f_{c}+f₀−(f_{z}+δ)). In an example embodiment, the motional frequency is a sum of the motional mode frequency f_{z} of the confinement apparatus and a mode detuning δ. In various embodiments, the motional mode frequency f_{z} is a function of the voltages applied to control electrodes and/or radio frequency electrodes of the confinement apparatus (e.g., by the potential drivers of the quantum computer 110). For example, the motional mode frequency f_{z} is determined at least in part based on the topology of the potential well in which the two or more quantum objects 52A, 52B are disposed. In various embodiments, the mode detuning δ is in a range between 1 kHz and 1 MHz (e.g., corresponding to gate times between 1 ms and 1 μs). In various embodiments, the mode detuning δ is less than 1 kHz or greater than 1 MHz. In various embodiments, the mode detuning δ is used to determine the length of time the gate is performed for (e.g., the length of time the first, second, third, and fourth manipulation signals are applied to the defined location 54 to cause performance of the gate). In various embodiments, the length of time of the gate is proportional to 1/δ.

In an example embodiment where the first frequency is equal to the Raman laser frequency modified by the carrier detuning (f₁=f_{c}+Δ), the fourth frequency is also modified by Δ so that the difference between the first frequency and the second frequency is the difference between the qubit frequency and the motional frequency. For example, when f₁=f_{c}+Δ, f₄=f_{c}+f₀−(f_{z}+δ)+Δ.

In various embodiments, the first manipulation signal 232 and the fourth manipulation signal 238 interact at the defined location 54 to generate a red sideband signal 250. In particular, the frequency difference between the first frequency f₁ and the fourth frequency f₄ (e.g., f₀−(f_{z}+δ)) corresponds to a red sideband interaction of the first and second qubit states 312, 314. For example, the frequency difference between the first frequency f₁ and the fourth frequency f₄ corresponds to the energy difference between the second qubit state 314 (e.g., the lower energy qubit state of the qubit space 310) and the red virtual state 316B. Thus, when the red sideband signal generated through the interaction of the first manipulation signal 232 and the fourth manipulation signal 238 interact at the defined location 54 and are incident on the quantum objects 52A, 52B disposed at the defined location 54, the red sideband signal causes a red sideband interaction of quantum objects 52A, 52B.

In various embodiments, the second manipulation signal 234 and the third manipulation signal 236 interact at the defined location 54 to generate a blue sideband signal 260. In particular, the frequency difference between the second frequency f₂ and the third frequency f₃ (e.g., f₀+(f_{z}+δ)) corresponds to a blue sideband interaction of the first and second qubit states 312, 314. For example, the frequency difference between the second frequency f₂ and the third frequency f₃ corresponds to the energy difference between the second qubit state 314 (e.g., the lower energy qubit state of the qubit space 310) and the blue virtual state 316A. Thus, when the blue sideband signal generated through the interaction of the second manipulation signal 234 and the third manipulation signal 236 interact at the defined location 54 and are incident on the quantum objects 52A, 52B disposed at the defined location 54, the blue sideband signal causes a blue sideband interaction of quantum objects 52A, 52B.

The red sideband signal and the blue sideband signal being incident on the quantum objects 52A, 52B at the defined location 54 simultaneously causes the interaction and/or entanglement of the quantum objects 52A, 52B of the MS gate. Additionally, because both the red sideband signal and the blue sideband signal are formed from a respective manipulation signal provided along the first optical path 240 and a respective manipulation signal provided along the second optical path 242, the relative phase difference between the red sideband signal and the blue sideband signal is substantially constant and/or insensitive to changes in the optical path length of the first optical path 240 and/or the second optical path 242. This causes the MS gate disclosed herein to be a phase insensitive MS gate.

In an example embodiment, each of the first, second, third, and fourth manipulation signals 232, 234, 236, 238 are linearly polarized and the respective polarizations are perpendicular to the magnetic field direction 55. In an example embodiment, the respective polarizations of the first and second manipulation signals 232, 234 are perpendicular to one another and are each perpendicular to the magnetic field direction 55. In an example embodiment, the polarizations of the third and fourth manipulation signals 236, 238 are perpendicular to one another and are each perpendicular to the magnetic field direction 55.

FIG. 2 further illustrates the red sideband wave vector kᵣ, which is the wave vector of the red sideband signal 250, and the blue sideband wave vector k_{b}, which is the wave vector of the blue sideband signal 260. In various embodiments, two quantum objects 52A, 52B are disposed at the defined location 54 to be entangled via an MS gate of an example embodiment with a distance d between the two quantum objects 52A, 52B. In various embodiments, the distance d is measured in a direction substantially parallel to an axis of the confinement apparatus (e.g., an RF null of the confinement apparatus in an example embodiment where the confinement apparatus is a surface ion trap) at the defined location 54. In an example embodiment, the distance d is substantially equal to an integer multiple of π divided by the amplitude of the red sideband wave vector |kᵣ| and/or the amplitude of the blue sideband wave vector |k_{b}| (e.g., d=nπ/|kᵢ|, where n is a positive integer, and kᵢ is the red sideband wave vector kᵣ and/or the blue sideband wave vector k_{b}). In an example embodiment, the distance d is substantially equal to a half odd integer multiple of π divided by the amplitude of the red sideband wave vector |kᵣ| and/or the amplitude of the blue sideband wave vector |k_{b}| (e.g., d=(nπ(2|kᵢ|), where n is a positive odd integer (e.g., 3, 5, 7, and/or the like), and kᵢ is the red sideband wave vector kᵣ and/or the blue sideband wave vector k_{b}).

In various embodiments, the first optical path 240 and the second optical path 242 are separated by a non-zero angle α at the defined location 54. In various embodiments, the angle α is in the range of 30 degrees to 150 degrees. In an example embodiment, the angle α is substantially equal to 90 degrees. In various embodiments, the angle α may have various non-zero values (e.g., α≠0), as appropriate for the application.

In an example embodiment, the magnetic field direction 55 at the defined location 54 is parallel to one of first optical path 240 or the second optical path 242. In various embodiments, the magnetic field direction 55 is transverse and/or not parallel to both the first optical path 240 and the second optical path 242, as appropriate for the application.

While FIG. 2 illustrates one instance of the four-tone phase insensitive MS gate being performed at one defined location 54 on one pair of quantum objects 52A, 52B, it should be understood that, in various embodiments, four-tone phase insensitive MS gates may be performed simultaneously and/or in parallel at a plurality of defined locations of the confinement apparatus 50 on respective pairs of quantum objects. For example, in an example embodiment, the first, second, third, and fourth manipulation signals generated by the one or more manipulation sources 64 are split and provided to multiple defined locations 54 of the confinement apparatus 50 simultaneously and/or in parallel via respective first and second optical paths (e.g., defined by one or more beam path systems 66).

### Example Method of Performing a Four-Tone Phase Insensitive MS Gate

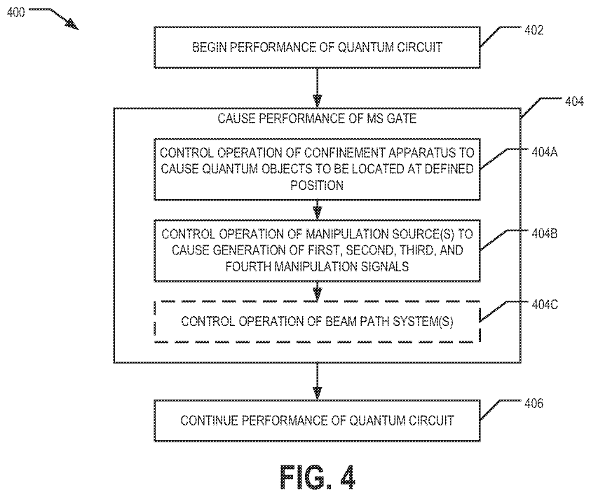

FIG. 4 provides a flowchart illustrating processes, procedures, operations, and/or the like performed, for example, by a controller 30 of the quantum computer 110, for performing a four-tone phase insensitive MS gate, according to an example embodiment. Starting at step/operation 402, the performance of a quantum circuit is initiated. For example, the controller 30 initiates the performance of a quantum circuit by the quantum computer 110. For example, the controller 30 may begin executing an executable queue to cause various components of the quantum computer 110 to perform operations and/or functions that cause the quantum computer 110 to begin executing the quantum circuit.

The quantum circuit includes one or more two or more qubit gates that include a four-tone phase insensitive MS gate as a gate primitive thereof. As should be understood, a set of gate primitive are gates that enact unitary transformations and that can be combined (e.g., performed in sequences) to enact construct a complete universal quantum computation set (e.g., a universal set of gates for quantum computation).

Thus, at step/operation 404, the controller 30 causes the four-tone phase insensitive MS gate to be performed on a set of quantum objects (e.g., a pair of quantum objects) indicated by the quantum circuit. For example, the controller 30 controls one or more components of the quantum computer 110 to cause the quantum computer 110 to perform the four-tone phase insensitive MS gate on the set of quantum objects.

For example, at step/operation 404A, the controller 30 controls operation of the confinement apparatus 50 to cause the set of quantum objects to be located and/or disposed at the defined location 54. For example, the controller 30 may control operation of one or more potential drivers operatively connected to the confinement apparatus 50 to control, for example, the electric potential experienced by one or more quantum objects confined by the confinement apparatus 50. For example, the controller 30 may control operation of the confinement apparatus 50 to cause each quantum object of the set of quantum objects to be transported to the defined location 54 and maintained at the defined location. In an example embodiment, the controller 30 controls operation of the confinement apparatus 50 such that the set of quantum objects 52A, 52B are located and/or disposed at the defined location 54 with a separation between them of a distance d.

For example, at step/operation 404B, the controller 30 controls operation of one or more manipulation sources 64 to cause a first manipulation signal 232, second manipulation signal 234, third manipulation signal 236, and fourth manipulation signal 238 to be generated. the controller 30 controls operation of the one or more manipulation sources 64 to cause the first manipulation signal 232 and the second manipulation signal 234 to be provided to a first optical path 240 defined by one or more beam path systems 66 and to cause the third manipulation signal 236 and the fourth manipulation signal 238 to be provided to a second optical path 242 defined by the one or more beam path systems 66. In various embodiments, there is a non-zero angle α between the first optical path 240 and the second optical path 242 at the defined location 54.

In various embodiments, the first manipulation signal 232 is characterized by a first frequency f₁. In various embodiments, the first frequency f₁ corresponds to a Raman laser frequency f_{c}. In an example embodiment, the first frequency f₁ equals the Raman laser frequency f_{c}. In an example embodiment, the first frequency f₁ is equal to the Raman laser frequency f_{c} plus a carrier detuning Δ. In an example embodiment, the carrier detuning Δ is in a range of 100 kHz to 100 MHz. For example, in an example embodiment, the carrier detuning is selected within the range 1 to 10 MHz.

In various embodiments, the second manipulation signal 234 is characterized by a second frequency f₂. In various embodiments the second frequency f₂ corresponds to a sum of the Raman laser frequency f_{c}, the qubit frequency f₀, and a motional frequency of the two or more quantum objects 52A, 52B. In an example embodiment, the second frequency f₂ equals the sum of the Raman laser frequency f_{c}, the qubit frequency f₀, and a motional frequency (f_{z}+δ) of the two or more quantum objects 52A, 52B (e.g., f₂=f_{c}+f₀+(f_{z}+δ)). In an example embodiment, the motional frequency is a sum of the motional mode frequency f_{z} of the confinement apparatus and a mode detuning δ. In various embodiments, the motional mode frequency f_{z} is a function of the voltages applied to control electrodes and/or radio frequency electrodes of the confinement apparatus (e.g., by the potential drivers of the quantum computer 110). For example, the motional mode frequency f_{z} is determined at least in part based on the topology of the potential well in which the two or more quantum objects 52A, 52B are disposed. In various embodiments, the mode detuning δ is in a range between 1 kHz and 1 MHz (e.g., corresponding to gate times between 1 ms and 1 μs). In various embodiments, the mode detuning δ is less than 1 kHz or greater than 1 MHz. In various embodiments, the third manipulation signal 236 is characterized by a third frequency f₃. In various embodiments, the third frequency f₃ corresponds to a Raman laser frequency f_{c}. In an example embodiment, the third frequency f₃ equals the Raman laser frequency f_{c}.

In various embodiments, the fourth manipulation signal 238 is characterized by a fourth frequency f₄. In various embodiments the fourth frequency f₄ corresponds to the Raman laser frequency f_{c} plus the qubit frequency f₀ and minus a motional frequency of the two or more quantum objects 52A, 52B. In an example embodiment, the fourth frequency f₄ equals the Raman laser frequency f_{c} plus the qubit frequency f₀ and minus a motional frequency (f_{z}+δ) of the two or more quantum objects 52A, 52B (e.g., f₂=f_{c}+f₀−(f_{z}+δ)). In an example embodiment, the motional frequency is a sum of the motional mode frequency f_{z} of the confinement apparatus and a mode detuning δ. In various embodiments, the motional mode frequency f_{z} is a function of the voltages applied to control electrodes and/or radio frequency electrodes of the confinement apparatus (e.g., by the potential drivers of the quantum computer 110). For example, the motional mode frequency f_{z} is determined at least in part based on the topology of the potential well in which the two or more quantum objects 52A, 52B are disposed. In various embodiments, the mode detuning δ is in a range between 1 kHz and 1 MHz (e.g., corresponding to gate times between 1 ms and 1 μs). In various embodiments, the mode detuning S is less than 1 kHz or greater than 1 MHz. In an example embodiment where the first frequency is equal to the Raman laser frequency modified by the carrier detuning (f₁=f_{c}+Δ), the fourth frequency is also modified by Δ so that the difference between the first frequency and the second frequency is the difference between the qubit frequency and the motional frequency. For example, when f₁=f_{c}+Δ, f₄=f_{c}+f₀−(f_{z}+δ)+Δ.

In various embodiments, the one or more beam path systems 66 that define the first and second optical paths 240, 242 include active components (e.g., modulators, amplifiers, switches, and/or the like). In such embodiments, at step/operation 404C, the controller 30 controls operation of the active components of the one or more beam path systems 66 to cause the beam path systems 66 to provide the first manipulation signal 232 and the second manipulation signal 234 to the defined location 54 along the first optical path 240 and to provide the third manipulation signal 236 and the fourth manipulation signal 238 along the second optical path 242.

In various embodiments, the first manipulation signal 232 and the fourth manipulation signal 238 interact at the defined location 54 to generate a red sideband signal 250. In particular, the frequency difference between the first frequency f₁ and the fourth frequency f₄ (e.g., f₀−(f_{z}+δ)) corresponds to a red sideband interaction of the first and second qubit states 312, 314. For example, the frequency difference between the first frequency f₁ and the fourth frequency f₄ corresponds to the energy difference between the second qubit state 314 (e.g., the lower energy qubit state of the qubit space 310) and the red virtual state 316B. Thus, when the red sideband signal generated through the interaction of the first manipulation signal 232 and the fourth manipulation signal 238 interact at the defined location 54 and are (simultaneously) incident on the quantum objects 52A, 52B disposed at the defined location 54, the red sideband signal causes a red sideband interaction of quantum objects 52A, 52B.

In various embodiments, the second manipulation signal 234 and the third manipulation signal 236 interact at the defined location 54 to generate a blue sideband signal 260. In particular, the frequency difference between the second frequency f₂ and the third frequency f₃ (e.g., f₀+(f_{z}+δ)) corresponds to a blue sideband interaction of the first and second qubit states 312, 314. For example, the frequency difference between the second frequency f₂ and the third frequency f₃ corresponds to the energy difference between the second qubit state 314 (e.g., the lower energy qubit state of the qubit space 310) and the blue virtual state 316A. Thus, when the blue sideband signal generated through the interaction of the second manipulation signal 234 and the third manipulation signal 236 interact at the defined location 54 and are (simultaneously) incident on the quantum objects 52A, 52B disposed at the defined location 54, the blue sideband signal causes a blue sideband interaction of quantum objects 52A, 52B.

The red sideband signal and the blue sideband signal being incident on the quantum objects 52A, 52B at the defined location 54 simultaneously causes the interaction and/or entanglement of the quantum objects 52A, 52B of the MS gate. Additionally, because both the red sideband signal and the blue sideband signal are formed from a respective manipulation signal provided along the first optical path 240 and a respective manipulation signal provided along the second optical path 242, the relative phase difference between the red sideband signal and the blue sideband signal is substantially constant and/or insensitive to changes in the optical path length of the first optical path 240 and/or the second optical path 242. This causes the MS gate disclosed herein to be a phase insensitive MS gate.

In various embodiments, the mode detuning δ is used to determine the length of time the gate is performed for (e.g., the length of time the first, second, third, and fourth manipulation signals are applied to the defined location 54 to cause performance of the gate). In various embodiments, the length of time of the gate is proportional to 1/δ. For example, in various embodiments, the first manipulation signal 232, second manipulation signal 234, third manipulation signal 236, and fourth manipulation signal 238 are (simultaneously) provided to the defined location 54 for a gate time that is a length of time that is proportional to the inverse of the mode detuning 1/δ and/or substantially equal to the inverse of the mode detuning 1/δ.

After the first manipulation signal 232, second manipulation signal 234, third manipulation signal 236, and fourth manipulation signal 238 have been (simultaneously) provided to the defined location 54 for the gate time, the controller 30 controls operation of the one or more beam path systems 66 and/or one or more manipulation sources 64 to cause the first manipulation signal 232, second manipulation signal 234, third manipulation signal 236, and fourth manipulation signal 238 to stop being provided to the defined location 54. For example, after the first manipulation signal 232, second manipulation signal 234, third manipulation signal 236, and fourth manipulation signal 238 have been (simultaneously) provided to the defined location 54 for the gate time, the performance of the four-tone phase insensitive MS gate is complete and the controller 30 causes the first manipulation signal 232, second manipulation signal 234, third manipulation signal 236, and fourth manipulation signal 238 to stop being provided to the defined location 54.

After performance of the four-tone phase insensitive MS gate, the controller 30 continues performance of the quantum circuit, at step/operation 406. For example, the controller 30 continues executing an executable queue configured to cause the quantum computer 110 to perform the quantum circuit. For example, the controller 30 may control operation of one or more components of the quantum computer 110 to cause the quantum computer to continue performing the quantum circuit. In various embodiments, continuing to perform the quantum circuit may include the performance of one or more four-tone phase insensitive MS gates, performance of one or more single qubit or other two or more qubit gates, performance of various transportation operations, qubit reading operations, cooling operations, leakage suppression operations, and/or the like, as appropriate for the quantum circuit.

### Technical Advantages

In various embodiments of a quantum computer, sequences of various quantum logic gates are performed on qubits to perform a quantum calculation, program, and/or circuit. The Mølmer-Sørensen (MS) gate is a two-qubit (or possibly more than two-qubit) entangling interaction that is commonly used as a building block of a universal quantum computation set. For example, a controlled NOT gate (a CNOT gate) can be decomposed into a sequence of single-qubit gates and an MS gate. Conventionally, in QCCD-based quantum computers, MS gates are performed using three laser beams in either a phase sensitive geometry or a phase insensitive geometry.

In the three beam phase sensitive geometry, the gate is performed by causing three laser beams to be incident on a pair of qubit ions. The red-shifted beam and the blue-shifted beam are co-propagating and a central frequency laser beam is not co-propagating with the red-shifted and blue-shifted beams. The frequency difference between the two co-propagating laser beams is approximately the motional frequency of the qubit ions. In the phase sensitive geometry, the spin phase of the gate, which controls the axis of the two-qubit rotation caused by the gate, is sensitive to fluctuations or changes in the relative beam path lengths of the two beam paths. This requires application of additional single qubit gates to address this phase sensitivity. These additional single qubit gates may introduce additional noise into the computation.

In the three beam phase insensitive geometry, the gate is also performed by causing three laser beams to be incident on a pair of qubit ions. Two of the laser beams (e.g., the red-shifted beam and the blue-shifted beam) are co-propagating and the third laser beam (e.g., a central frequency beam) does not co-propagate with the first two laser beams. The frequency difference of the co-propagating red-shifted beam and the blue-shifted beam is approximately twice the qubit frequency (e.g., approximately 25 GHz in the case of a Yb⁺ qubit). Generating beams with this frequency difference is technically challenging and may require an additional laser source.

Therefore, technical challenges exist regarding performance of a high fidelity, low noise MS gate that is technically feasible to implement.

Embodiments disclosed herein provide a technical solution to these technical problems. In particular, various embodiments provide a four-tone (e.g., four manipulation signal) phase insensitive MS gate where the four manipulation signals are straight forward to generate using two laser sources. In various embodiments, the laser frequencies only need to be split by approximately the qubit frequency f₀ (e.g., approximately 12.5 GHz when the quantum objects are singly ionized Yb¹⁷¹), rather than by twice the qubit frequency f₀ (e.g., approximately 25 GHz when the quantum objects are singly ionized Yb¹⁷¹). Splitting the laser frequencies by only the qubit frequency f₀ is technically significantly easier than splitting the laser frequencies by two times the qubit frequency f₀.

More than two laser sources may be used in various embodiments to generate the four manipulation signals. Because the disclosed MS gate is phase insensitive, the additional single qubit gates used to address the phase sensitivity of the three beam phase sensitive MS gate are not needed. Thus, various embodiments of the MS gate disclosed herein provide higher fidelity, lower noise MS gates compared to conventional MS gates while being technically straight forward to implement in light of the disclosure provided herein. Various embodiments therefore provide improvements to the technical fields of quantum computing and controlled quantum state evolution of quantum objects.

### Exemplary Controller

In various embodiments, a quantum computer 110 further comprises a controller 30 configured to control various elements and/or components of the quantum computer 110. In various embodiments, a controller 30 may be configured to cause a quantum computer 110 to perform various operations (e.g., computing operations such as gate operations, cooling operations, transport operations, qubit interaction operations, qubit reading operations, leakage suppression operations, and/or the like). For example, the controller 30 may be configured to cause one or more manipulation sources 64 to provide first, second, third, and fourth manipulation signals to enact a four-tone phase insensitive MS gate of an example embodiment. In various embodiments, the controller 30 may be configured to control operation of a cryogenic system and/or vacuum system controlling the temperature and pressure within the cryogenic and/or vacuum chamber 40, manipulation sources 64, beam path systems 66, confinement apparatus 50, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more quantum objects 52 confined by the confinement apparatus 50.

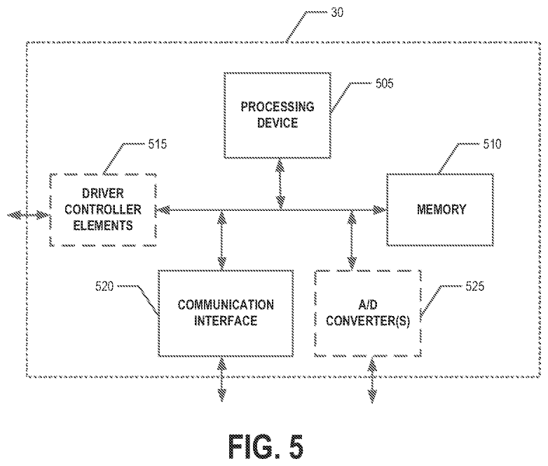

As shown in FIG. 5, in various embodiments, the controller 30 may comprise various controller elements including processing device 505, memory 510, driver controller elements 515, a communication interface 520, analog-digital converter elements 525, and/or the like. For example, the processing device 505 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like, and/or controllers. The term circuitry may refer to an entirely hardware embodiment or a combination of hardware and computer program products. In an example embodiment, the processing device 505 of the controller 30 comprises a clock and/or is in communication with a clock.

For example, the memory 510 may comprise non-transitory (classical and/or semiconductor-based) memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 510 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 510 (e.g., by a processing device 505) causes the controller 30 to perform one or more steps, operations, processes, procedures and/or the like described herein.

In various embodiments, the driver controller elements 515 may include one or more drivers and/or controller elements each configured to control one or more drivers. In various embodiments, the driver controller elements 515 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 505). In various embodiments, the driver controller elements 515 may enable the controller 30 to operate manipulation sources 64, optical beam path systems 66, the confinement apparatus 50, vacuum and/or cryogenic systems, and/or the like. In various embodiments, the drivers may be laser drivers; microwave drivers; vacuum component drivers; cryogenic and/or vacuum system component drivers; current drivers; potential drivers; voltage sources; and/or the like. For example, the drivers and/or driver controllers may be configured to cause the magnetic field generation device 70 (e.g., comprising circuitry coupled to a voltage source (e.g., a current driver or voltage driver), permanent magnet(s), and/or a combination thereof) to generate a magnetic field having a particular direction and magnitude at one or more positions of the confinement apparatus 50. In various embodiments, the controller 30 comprises means for communicating and/or receiving signals from one or more optical receiver components such as photodetectors, cameras, MEMs cameras, CCD cameras, photodiodes, photomultiplier tubes, and/or the like. For example, the controller 30 may comprise one or more analog-digital converter elements 525 configured to receive signals from one or more optical receiver components, calibration sensors, and/or the like.

In various embodiments, the controller 30 may comprise a communication interface 520 for interfacing and/or communicating with a computing entity 10. For example, the controller 30 may comprise a communication interface 520 for receiving executable instructions, command sets, and/or the like from the computing entity 10 and providing output received from the quantum computer 110 (e.g., from an optical collection system) and/or the result of a processing the output to the computing entity 10. In various embodiments, the computing entity 10 and the controller 30 may communicate via a direct wired and/or wireless connection and/or one or more wired and/or wireless networks 20.

### Exemplary Computing Entity

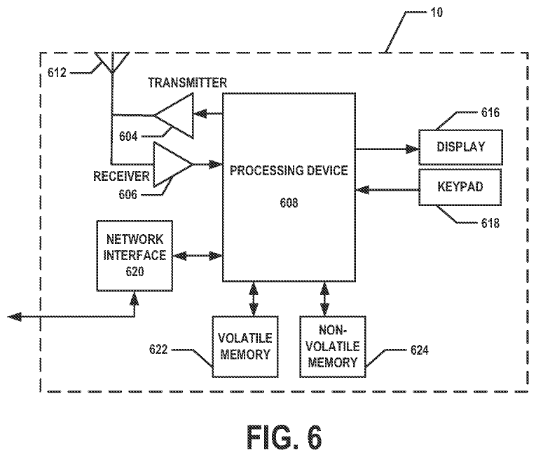

FIG. 6 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110. For example, a user may operate a computing entity 10 to generate and/or program a quantum algorithm and/or quantum circuit (e.g., that includes a four-tone phase insensitive MS gate) that may be provided such that the controller 30 may receive the quantum algorithm and/or quantum circuit and cause the quantum computer 110 to perform the quantum algorithm and/or quantum circuit.

As shown in FIG. 6, a computing entity 10 can include an antenna 612, a transmitter 604 (e.g., radio), a receiver 606 (e.g., radio), and a processing device 608 that provides signals to and receives signals from the transmitter 604 and receiver 606, respectively. The signals provided to and received from the transmitter 604 and the receiver 606, respectively, may include signaling information/data in accordance with an air interface standard of applicable wireless systems to communicate with various entities, such as a controller 30, other computing entities 10, and/or the like.

In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like. In various embodiments, the computing entity 10 includes a network interface 620 configured to enable the computing entity 10 to communicate via one or more wired and/or wireless networks.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

In various embodiments, the computing entity comprises a processing device 608. For example, the processing device 608 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like, and/or controllers. The term circuitry may refer to an entirely hardware embodiment or a combination of hardware and computer program products.

The computing entity 10 may also comprise a user interface device comprising one or more user input/output interfaces (e.g., a display 616 and/or speaker/speaker driver coupled to a processing device 608 and a touch screen, keyboard, mouse, and/or microphone coupled to a processing device 608). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 618 (hard or soft), a touch display, voice/speech or motion interfaces, scanners, readers, or other input device. In embodiments including a keypad 618, the keypad 618 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 622 and/or non-volatile storage or memory 624, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system configured for performing a Mølmer-Sørensen (MS) gate, the system comprising:
a confinement apparatus configured to confine one or more quantum objects at a defined location, wherein a qubit space of the one or more quantum objects is defined to comprise two qubit states;
one or more manipulation sources configured to generate a first manipulation signal, a second manipulation signal, a third manipulation signal, and a fourth manipulation signal, wherein the first manipulation signal and the fourth manipulation signal are configured, when the first manipulation signal and the fourth manipulation signal interact, to provide a red sideband signal corresponding to a Raman transition between the two qubit states and the second manipulation signal and the third manipulation signal are configured, when the second manipulation signal and the third manipulation signal interact, to provide a blue sideband signal corresponding to the Raman transition between the two qubit states; and
one or more beam path systems, wherein the one or more beam path systems define a first beam path and a second beam path, the first beam path is configured to provide the first manipulation signal and the second manipulation signal to the defined location and the second beam path is configured to provide the third manipulation signal and the fourth manipulation signal to the defined location, wherein there is a non-zero angle between the first beam path and the second beam path at the defined location.

2. The system of claim 1, wherein (a) a qubit frequency is defined based on an energy difference between the two qubit states of the qubit space of the one or more quantum objects, (b) a first frequency of the first manipulation signal corresponds to a Raman laser frequency, (c) a second frequency of the second manipulation signal corresponds to a sum of the Raman laser frequency, the qubit frequency, and a motional frequency of the two or more quantum objects, (d) a third frequency of the third manipulation signal corresponds to the Raman laser frequency, and (e) a fourth frequency of the fourth manipulation signal corresponds to the Raman laser frequency plus the qubit frequency minus the motional frequency.

3. The system of claim 2, wherein one of (a) the first frequency is equal to the Raman laser frequency plus a carrier detuning and the fourth frequency is equal to the Raman laser frequency plus the qubit frequency minus the motional frequency plus the carrier detuning or (b) the second frequency is equal to the sum of the Raman laser frequency, the qubit frequency, and a motional frequency plus the carrier detuning and the third frequency is equal to the Raman laser frequency plus the carrier detuning.

4. The system of claim 2, wherein the motional frequency is a sum of a motional mode frequency defined by the confinement apparatus and a mode detuning.

5. The system of claim 1, wherein the MS gate is a phase insensitive MS gate.

6. The system of claim 1, wherein the confinement apparatus is configured to cause two quantum objects of the one or more quantum objects to be located at the defined location with a separation distance between the two quantum objects to be one of an integer multiple or a half odd integer of π divided by an amplitude of a wave vector difference between (a) one of the first manipulation signal or the second manipulation signal and (b) one of the third manipulation signal or the fourth manipulation signal.

7. The system of claim 1, wherein the non-zero angle is an angle between thirty degrees and one hundred fifty degrees.

8. The system of claim 1, wherein a magnetic field direction at the defined location is configured to be substantially parallel to one of the first beam path or the second beam path at the defined location.

9. The system of claim 1, further comprising a controller configured to control operation of one or more of the confinement apparatus, the one or more manipulation sources, or the one or more beam path systems to cause the system to perform the MS gate.

10. A method for performing a Mølmer-Sørensen (MS) gate, the method comprising:
controlling operation of a confinement apparatus confining two or more quantum objects to cause the two or more quantum objects to be located at a defined location of the confinement apparatus, wherein a qubit space of the one or more quantum objects is defined to comprise two qubit states; and
controlling operation of one or more manipulation sources to cause generation of a first manipulation signal, a second manipulation signal, a third manipulation signal, and a fourth manipulation signal, wherein the first manipulation signal and the fourth manipulation signal are configured, when the first manipulation signal and the fourth manipulation signal interact, to provide a red sideband signal corresponding to a Raman transition between the two qubit states and the second manipulation signal and the third manipulation signal are configured, when the second manipulation signal and the third manipulation signal interact, to provide a blue sideband signal corresponding to the Raman transition between the two qubit states,
wherein the first manipulation signal and the second manipulation signal are provided to the defined location via a first beam path and the third manipulation signal and the fourth manipulation signal are provided to the defined location via a second beam path to cause the first manipulation signal and the fourth manipulation signal to interact to provide the red sideband signal and to cause the second manipulation signal and the third manipulation signal to interact to provide the blue sideband signal, and
wherein there is a non-zero angle between the first beam path and the second beam path at the defined location.

11. The method of claim 10, wherein (a) a qubit frequency is defined based on an energy difference between the two qubit states of the qubit space of the one or more quantum objects, (b) a first frequency of the first manipulation signal corresponds to a Raman laser frequency, (c) a second frequency of the second manipulation signal corresponds to a sum of the Raman laser frequency, the qubit frequency, and a motional frequency of the two or more quantum objects, (d) a third frequency of the third manipulation signal corresponds to the Raman laser frequency, and (e) a fourth frequency of the fourth manipulation signal corresponds to the Raman laser frequency plus the qubit frequency minus the motional frequency.

12. The method of claim 11, wherein one of (a) the first frequency is equal to the Raman laser frequency plus a carrier detuning and the fourth frequency is equal to the Raman laser frequency plus the qubit frequency minus the motional frequency plus the carrier detuning or (b) the second frequency is equal to the sum of the Raman laser frequency, the qubit frequency, and a motional frequency plus the carrier detuning and the third frequency is equal to the Raman laser frequency plus the carrier detuning.

13. The method of claim 11, wherein the motional frequency is a sum of a motional mode frequency defined by the confinement apparatus and a mode detuning.

14. The method of claim 10, wherein the MS gate is a phase insensitive MS gate.

15. The method of claim 10, wherein the operation of the confinement apparatus is controlled to cause the two or more quantum objects to be located at the defined location with a separation distance between two or the two or more quantum objects to be one of an integer multiple or a half odd integer of π divided by an amplitude of a wave vector difference between (a) one of the first manipulation signal or the second manipulation signal and (b) one of the third manipulation signal or the fourth manipulation signal.

16. The method of claim 10, wherein the MS gate is part of a quantum logic operation.

17. The method of claim 10, wherein the MS gate is performed as part of a quantum circuit.

18. The method of claim 10, further comprising controlling operation of one or more beam path systems defining the first beam path and the second beam path to cause the first manipulation signal and the second manipulation signal to be provided to the defined location via the first beam path and the third manipulation signal and the fourth manipulation signal to be provided to the defined location via a second beam path.

19. The method of claim 10, wherein at least a portion of the method is performed by a controller configured to control operation of one or more of the confinement apparatus, the one or more manipulation sources, or one or more beam path systems defining the first beam path and the second beam path.

20. The method of claim 10, wherein the non-zero angle is an angle between thirty degrees and one hundred fifty degrees.
